(19) United States
(12) Patent Application Publication
(10) Pub. No.: US 2005/0107275 A1
(43) Pub. Date: May 19, 2005

(54) Liquid detergent composition comprising a solubilizing nonionic surfactant

(76) Inventors: Stacie Ellen Hecht, West Chester, OH (US); Byong Koo Kim, Florence, KY (US); Rodolfo Delgado, Cincinnati, OH (US); Jeffrey John Scheibel, Lovelan, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/984,087

(22) Filed: Nov. 9, 2004

Related U.S. Application Data
(60) Provisional application No. 60/520,108, filed on Nov. 14, 2003.

(51) Int. Cl. C11D 1/00

(52) U.S. Cl. 510/237

(57) ABSTRACT

A liquid detergent composition comprising a limited amount of a solubilizing nonionic surfactant for increased speed of cooked grease cleaning and methods of using the same.

### CROSS-REFERENCES

This application claims priority under 35 U.S.C. § 119(e) to U.S. provisional application No. 60/520,108, filed Nov. 14, 2004.

### FIELD OF INVENTION

The present invention relates to a liquid detergent composition comprising a limited amount of a solubilizing nonionic surfactant for increased speed of cooked grease cleaning. The present invention also relates to light-duty liquid dishwashing detergent compositions and methods of using the same.

### BACKGROUND OF THE INVENTION

Increased grease cleaning for liquid detergents poses an ongoing problem for consumers. Grease cleaning may be classified in two forms: first, the total amount of grease cleaning or the grease suspending capacity: second, the speed of the grease cleaning or how fast grease is solubilized and removed from the desired surface. One approach to grease cleaning has been to improve the first form of grease cleaning and to soak or allow surfaces to stand for a period of time before being cleaned. However, the second form of grease cleaning is also a desired trait of liquid detergents by consumers. The speed of grease cleaning is desired as well as other visual indications of cleaning, such as suds profiles (high or low), feel, and smell by consumers in liquid detergents. A balance of these desired traits in a liquid detergent remains an unsolved problem.

The second form of grease cleaning (speed of grease cleaning) requires the solubilization and removal of grease deposits from a surface. Grease deposits, particularly cooked grease deposits are difficult to solubilize and remove by the second form of grease cleaning. A cooked grease deposit, verses an uncooked grease deposit, comprises a higher viscosity grease deposit that resists removal by liquid detergents. Oxidative degradation of the grease when exposed to cooking heats forms polymerized triglycerides that leads to more viscous cooked grease deposits which are comparatively more difficult to remove than uncooked grease deposits. It has been surprisingly found that to solubilize and remove the cooked grease deposits, surfactants having higher solubility in grease are required. Identification of such surfactants may be accomplished using a hydrophile-lipophile balance number, otherwise known as an HLB number.

Light-duty liquid dishwashing detergent compositions require a higher suds profile while providing not only the first form of grease cleaning but also the second form of grease cleaning. Additionally it has also surprisingly been found that the present invention gives improved speed of cooked grease cleaning while maintaining acceptable levels of total amount of grease cleaning and suds profile in a liquid dishwashing detergent composition.

### SUMMARY OF THE INVENTION

The present invention relates to a liquid detergent composition comprising a surfactant system comprising about 1.5 wt % to about 3.5 wt % of the liquid detergent composition of one or more solubilizing nonionic surfactants comprising a hydrophile-lipophile balance number less than 12.5.

The present invention further relates to a liquid detergent composition comprising a surfactant system comprising about 1.5 wt % to about 3.5 wt % of the liquid detergent composition of one or more solubilizing nonionic surfactants comprising a hydrophile-lipophile balance number less than 12.5, optionally an anionic surfactant, an amine oxide surfactant, and a nonionic surfactant other than the solubilizing nonionic surfactant; and from 30 wt % to 95 wt % by weight of the liquid detergent composition of an aqueous liquid carrier.

The present invention also relates to a method of washing dishes with the liquid detergent composition comprising the solubilizing nonionic surfactant.

All documents cited are, in relevant part, incorporated herein by reference; the citation of any document is not to be construed as an admission that it is prior art with respect to the present invention.

### DETAILED DESCRIPTION OF THE INVENTION

The liquid detergent compositions of the present invention surprisingly provide improved speed of cooked grease deposits. It has been found that inclusions of limited amounts of solubilizing nonionic surfactants having an optimal hydrophile-lipophile balance number, when used in a surfactant system, provide the benefit of improved speed of cooked grease cleaning. Additionally, the limited amounts of solubilizing nonionic surfactant give the multiple benefits of increase speed of cooked grease cleaning while maintaining or exceeding acceptable levels of total amount of grease cleaning and suds profile in a liquid dishwashing detergent composition.

As used herein “grease” means materials comprising at least in part (at least 0.5 wt % by weight of the grease) unsaturated fats and oils, preferably fats and oils comprising linoleic and linolenic acids, more preferably oils and fats derived from vegetable sources comprising linoleic and linolenic acids.

As used herein “cooked grease” means grease exposed to increased temperatures in a standard oven, convection oven, toaster oven, microwave oven, stove top heating using a frying pan, wok, hot plate, electric griddle, or other known cooking appliances used to heat food during cooking.

As used herein “suds profile” means high sudsing and the persistence of sudsing throughout the washing process resulting from the use of the liquid detergent composition of the present invention. This is particularly important as the consumer uses high sudsing as an indicator of the performance of the liquid detergent composition. Moreover, the consumer also uses the sudsing profile as an indicator that the wash solution still contains active detergent ingredients, renewing the wash solution when the sudsing subsides. Thus, a low sudsing formulation will tend to be replaced by the consumer more frequently than is necessary because of the low sudsing level.

As used herein “deposits” means cooked grease that are adhered to a surface, not limited in area or volume of cooked grease that is adhered to a surface such as dishes, glass, pots, pans, baking dishes, flatware or fabric.

As used herein “light-duty liquid dishwashing detergent composition” refers to those compositions that are employed in manual (i.e. hand) dishwashing. Such compositions are generally high sudsing or foaming in nature.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the liquid detergent composition. All temperatures, unless otherwise indicated are in Celsius.

Solublizing Nonionic Surfactants

It has surprisingly been found that limited amounts, from about 1.5% to about 3.5% by weight of the liquid detergent composition of one or more solubilizing nonionic surfactants is suitable for the present invention. It has been surprisingly been found that the inclusion of less than 1.5% and more than 3.5%, by weight of the liquid detergent composition, of a solubilizing nonionic surfactant does not demonstrate the desired speed in cooked grease cleaning as amounts of solubilizing nonionic surfactant within the specified weight percentages. Solubilizing nonionic surfactants that are suitable for use in the present invention are hydrophobic as determined by the solubilizing nonionic surfactant's hydrophile-lipophile balance number (HLB number). The HLB number may be found in standard references such as the Encyclopedia of Emulsion Technology, Vol. 1, 1985, P. Becher, editor; McCutcheon's Emulsifiers and Detergents, or calculated in the following manner:

$$HLB = 20 \times \frac{{M}_{H}}{{M}_{H} + {M}_{L}}$$

where M_{H} is the formula weight of the hydrophilic portion of the molecule and M_{L} is the formula weight of the lipophilic portion of the molecule. See M. Rosen, Surfactants and Interfacial Phenomena, Second Edition, page 328, New York, Wiley, 1989.

Suitable HLB numbers are preferably less than about 12.5, more preferably from about 4.3 to about 11.5, more preferably from about 7 to about 9.5. Preferred solubilizing nonionic surfactants are selected from the group consisting of alcohol alkoxylates, mid-chain branched alkoxylates, sorbitan monopalmitate, sorbitan monooleate, sorbitan monostearate, polyoxyethylene(4) sorbitan monostearate, polyoxyethylene(20) sorbitan tristearate, polyoxyethylene(5) sorbitan monooleate, polyoxyethylene(20) sorbitan trioleate, and mixtures thereof. Nonlimiting examples of solubilizing nonionic surfactants suitable for use in the present invention include those listed in Table I.

TABLE I

| Solubilizing Nonionic Surfactant | HLB |
|---|---|
| C₁₂₋₁₄ alkyl polysaccharide ether such as GLUCOPON ® 625 | 12 |
| from Cognis Corp.¹ | |
| C₁₄₋₁₅ alcohol ethoxylate EO = 7 such as SAFOL ® 45-7 from | 12.3 |
| Sasol² | |
| C₁₂₋₁₃ alcohol ethoxylate EO = 5 such as SAFOL ® 23-5 from | 11.5 |
| Sasol² | |
| C₁₂₋₁₄ secondary alcohol ethoxylate EO = 3 such as | 8.0 |
| TERGITOL ® 15S-3 from Dow Chemical¹ | |
| C₁₂₋₁₃ alcohol ethoxylate EO = 3 such as SAFOL ® 23-3 from | 9.1 |
| Sasol² | |
| oxo-alcohol C₁₂-C₁₃ EO = 3 ethoxylate (or alcohol C₁₂₋₁₃, poly (3) | 9.1 |
| ethoxylate) such as LIALET ® 123-3 from Sasol² | |
| synthetic C₁₃ oxo-alcohol EO = 3 such as LUTENSOL ® 94001 or | 8.9 |
| LUTENSOL ® TO 3 from BASF² | |
| synthetic C₁₃ oxo-alcohol EO = 5 such as LUTENSOL ® 94002 | 11.3 |
| (C₁₃E₅) or LUTENSOL ® TO 5² | |
| mid-chain branched C₁₂₋₁₃ alcohol ethoxylate EO = 3 such as | 9.1 |
| HSE 23-3² | |
| C₁₄₋₁₅ linear primary alcohol ethoxylate EO = 7 such as | 11.8 |
| NEODOL ® 45-7 from Shell¹ | |
| sorbitan monolaurate such as SPAN ® 20 from Uniqema¹ | 8.6 |
| sorbitan monopalmitate such as SPAN ® 40 from Uniqema¹ | 6.7 |
| sorbitan monostearate such as SPAN ® 60 from Uniqema¹ | 4.7 |
| sorbitan monooleate such as SPAN ® 80 from Uniqema¹ | 4.3 |
| polyoxyethylene EO = 4 sorbitan monostearate such as TWEEN ® | 9.6 |
| 61 from Uniqema¹ | |
| polyoxyethylene EO = 20 sorbitan tristearate such as TWEEN ® | 10.5 |
| 65 from Uniqema¹ | |
| polyoxyethylene EO = 5 sorbitan monooleate TWEEN ® 81 from | 10 |
| Uniqema¹ | |
| polyoxyethylene EO = 20 sorbitan trioleate TWEEN ® from | 11 |
| Uniqema¹ | |

¹Values from McCutcheon's Emulsifiers and Detergents
²Values calculated using method described in Surfactants and Interfacial Phenomena

Solubilizing nonionic surfactants having suitable HLB numbers include a variety of mid-chain branched surfactants, indicated in Table I above as “HSE”. As used herein “mid-chain branched” refers to surfactants, which generally comprise a hydrophobic and hydrophilic portion, having a hydrophobic portion wherein a C₁-C₄ alkyl branch is located on the hydrophobic portion as illustrated in formula (I) below. The solubilizing nonionic mid-chain branched surfactant may comprise one or more mid-chain branched primary alkyl polyoxyalkylene surfactants having the formula (I):

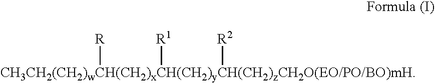

The solubilizing nonionic mid-chain branched surfactant of the present invention comprises molecules having a linear primary polyoxyalkylene chain backbone (i.e., the longest linear carbon chain which includes the alkoxylated carbon atom). These alkyl chain backbones comprise from 9 to 30 carbon atoms; and further the molecules comprise a branched primary alkyl moiety or moieties having at least about 1, but not more than 4, carbon atoms.

For example, a C₁₄ total carbon primary alkyl polyoxyalkylene surfactant having 11 carbon atoms in the backbone must have 1, 2 or 3 branching units (i.e. R, R¹ and R² of formula (II)) whereby the total number of carbon atoms in the molecule is 14. In this example, the C₁₄ total carbon requirement may be satisfied equally by having, for example, one propyl branching unit or three methyl branching units.

R, R¹, and R² of formula (II) are each independently selected from hydrogen and C₁-C₃ alkyl (preferably hydrogen or C₁-C₂ alkyl, more preferably hydrogen or methyl, and most preferably methyl), provided R, R¹, and R² of formula (II) are not all hydrogen. Further, when z of formula (H) is 0, at least R or R¹ of formula (II) is not hydrogen.

Further regarding the above formula (II), w of formula (H) is an integer from 0 to 10; x of formula (II) is an integer from 0 to 10; y of formula (II) is an integer from 0 to 10; z of formula (II) is an integer from 0 to 10; and w+x+y+z is a sum from 2 to 11.

EO/PO/BO of formula (II) are alkoxy moieties, preferably selected from ethoxy, propoxy, butoxy, and mixtures thereof, preferably ethoxy, wherein m of formula (II) is at least about 0.01, preferably within the range of from about 0.01 to about 10, more preferably from about 1 to about 7, and most preferably from about 3 to about 7. The (EO/PO/BO)ₘ moiety of formula (II) may be either a distribution with average degree of alkoxylation (e.g., ethoxylation, propoxylation, and/or butoxylation) corresponding to m, or it may be a single specific chain with alkoxylation (e.g., ethoxylation, propoxylation, and/or butoxylation) of exactly the number of units corresponding to m.

### EXAMPLE I

### Preparation of Sodium 7-methyltridecyl Ethoxylated (EO=2)

### 1.A. Synthesis of (6-hydroxyhexyl) Triphenylphosphonium Bromide

Add into a 5 L, 3 neck round bottom flask fitted with nitrogen inlet, condenser, thermometer, mechanical stirring and nitrogen outlet 6-bromo-1-hexanol (500 g, 2.76 mol), triphenylphosphine (768 g, 2.9 mol) and acetonitrile (1800 ml) under nitrogen. Heat the reaction mixture to reflux for 72 hrs. Cool the reaction mixture to room temperature (20° C.) and transfer the reaction mixture into a 5 L beaker. Recrystallize the product from anhydrous ethyl ether (1.5 L) at 10° C. Recover the product by vacuum filtration and then wash the product with ethyl ether and dry in a vacuum oven at 50° C. for 2 hrs. The process should give 1140 g of the desired product as white crystals.

### 1.B.

### Synthesis of 7-methyltridecene-1-ol

Add into a dried 5 L, 3 neck round bottom flask fitted with mechanical stirring, nitrogen inlet, dropping funnel, thermometer and nitrogen outlet 70.2 g of 60% sodium hydride (1.76 mol) in mineral oil. Remove the mineral oil by washing with hexanes. Add anhydrous dimethyl sulfoxide (500 ml) to the flask and heat the mixture to 70° C. until evolution of hydrogen stops. Cool the reaction mixture to room temperature (20° C.) and add 1 L of anhydrous tetrahydrofuran. (6-hydroxyhexyl) triphenylphosphonium bromide (443.4 g, 1 mol) and slurry with warm anhydrous dimethyl sulfoxide (50° C., 500 ml) and slowly add to the reaction mixture through the dropping funnel while keeping it at 25-30° C. Stir the mixture for 30 minutes at room temperature (20° C.) and slowing add 2-octanone (140.8 g, 1.1 mol) through a dropping funnel. Reaction is slightly exothermic and cooling is needed to maintain the temperature of the reaction mixture at 25-30° C. Stir the mixture for 18 hr. and pour into a 5 L beaker containing 1 L purified water with stirring. The oil phase (top) is allowed to separate out in a separatory funnel and remove the water phase. Wash the water phase with hexanes (500 ml) and separate the organic phase and combine with the oil phase from the water wash. Extract the organic mixture with water 3 times (500 ml each) and use vacuum distillation to collect the clear, oily product (110 g) at 140° C. and 133 Pa (1 mm Hg).

### 1.C. Hydrogenation of 7-methyltridecene-1-ol

Add into a 3 L rocking autoclave liner 7-methyltridecene-1-ol (108 g, 0.508 mol), methanol (300 ml) and platinum on carbon (10% by weight, 35 g). Hydrogenate the mixture at 180° C. under 8.39 MPa (1200 psig) of hydrogen for 13 hrs. Cool and vacuum filter the mixture through CELITE® 545 with washing of the CELITE® 545, suitably with methylene chloride. If needed, the filtration can be repeated to eliminate traces of platinum catalyst and magnesium sulfate can be used to dry the product. Concentrate the solution of product on a rotary evaporator to obtain a clear oil (104 g).

### 1.D. Alkoxylation of 7-methyltridecanol

Add into a dried 1 L 3 neck round bottom flask fitted with a nitrogen inlet, mechanical stirrer, and a y-tube fitted with a thermometer and a gas outlet the alcohol from the preceding step. For purposes of removing trace amounts of moisture, sparge the alcohol with nitrogen for about 30 minutes at 80-100° C. Continuing with a nitrogen sweep, add sodium metal as the catalyst and allow to melt with stirring at 120-140° C. With vigorous stirring, add ethylene oxide gas in 140 minutes while keeping the reaction temperature at 120-140° C. Add the correct weight (equal to two equivalents of ethylene oxide) of ethylene, sweep nitrogen through the apparatus for 20-30 minutes as the sample is cooled. The desired 7-methyltridecyl ethoxylate (average of 2 ethoxylates per molecule) product should be produced.

Aqueous Liquid Carrier

The light duty dishwashing detergent compositions herein may further contain from about 30% to 95% of an aqueous liquid carrier in which the essential and optional compositions components are dissolved, dispersed or suspended. More preferably the aqueous liquid carrier will comprise from about 50% to 90% by weight of the liquid detergent composition herein.

One component of the aqueous liquid carrier is water. The aqueous liquid carrier, however, may contain other materials which are liquid, or which dissolve in the liquid carrier, at room temperature (20° C.) and which may also serve some other function besides that of inert filler. Such materials can include, for example, hydrotropes and solvents, discussed in more detail below. Dependent on the geography of use of the liquid detergent composition of the present invention, the water in the aqueous liquid carrier can have a hardness level of about 2-30 gpg (“gpg” is a measure of water hardness that is well known to those skilled in the art, and it stands for “grains per gallon”).

Surfactants—The liquid detergent composition of the present invention may further comprise a surfactant other than the solubilizing nonionic surfactant selected from nonionic, anionic, cationic surfactants, ampholytic, zwitterionic, semi-polar nonionic surfactants such as amine oxide surfactants, and mixtures thereof. Optional surfactants, when present, may comprises from about 0.01% to about 50% by weight of the liquid detergent compositions of the present invention, preferably from about 1% to about 50 wt % by weight of the liquid detergent composition. Non-limiting examples of optional surfactants are discussed below.

Anionic Surfactants

Nonlimiting examples of optional anionic surfactants useful herein include C₁₁-C₁₈ alkyl benzene sulfonates (LAS); C₁₀-C₂₀ primary, branched-chain and random alkyl sulfates (AS); C₁₀-C₁₈ secondary (2,3) alkyl sulfates; C₁₀-C₁₈ alkyl alkoxy sulfates (AE_{X}S) wherein preferably x is from 1-30; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulfonate (MES); and alpha-olefin sulfonate (AOS).

Typically, when present, anionic surfactants may comprise from about 5% to about 50%, preferably from about 10% to 40% by weight of the liquid detergent composition.

Amine Oxide Surfactants

Other surfactants that may be used in the liquid detergent composition of the present invention are amine oxide surfactants. Amine oxides surfactants, for optional use herein, include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Preferred amine oxide surfactants have formula (IVI): 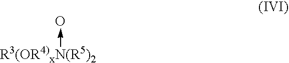
wherein R³ of formula (IVI) is an alkyl, hydroxyalkyl, alkyl phenyl group, and mixtures thereof containing from about 8 to about 22 carbon atoms; R⁴ of formula (IVI) is an alkylene or hydroxyalkylene group containing from about 2 to about 3 carbon atoms or mixtures thereof; x is from 0 to about 3; and each R⁵ of formula (IVI) is an alkyl or hydroxyalkyl group containing from about 1 to about 3 carbon atoms or a polyethylene oxide group containing from about 1 to about 3 ethylene oxide groups. The R⁵ groups of formula (IVI) can be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides.

When present, an amine oxide surfactant will be present in the liquid detergent composition from at least about 0.1% to about 20%, more preferably at least about 0.2% to about 15%, even more preferably still, at least about 0.5% to about 10% by weight of the liquid detergent composition of amine oxide surfactant. Further examples of suitable amine oxide surfactants are given in “Surface Active Agents and Detergents” (Vol. I and II by Schwartz, Perry and Berch).

Nonionic Surfactants

Non-limiting examples of nonionic surfactants that may be used in addition to the solubilizing nonionic surfactants of the present invention include C₁₂-C₁₈ alkyl ethoxylates, such as those derived from NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as PLURONIC® from BASF; C₁₄-C₂₂ mid-chain branched alcohols, BA, as discussed in U.S. Pat. No. 6,150,322; C₁₄-C₂₂ mid-chain branched alkyl alkoxylates, BAE, wherein x is from 1-30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; Polyhydroxy fatty acid amides (GS-base) as discussed in U.S. Pat. No. 5,332,528, WO 92/06162, WO 93/19146, WO 93/19038, and WO 94/09099; and ether capped poly(oxyalkylated) alcohol surfactants as discussed in U.S. Pat. No. 6,482,994 and WO 01/42408.

Typically, when present, nonionic surfactants that may be used in addition to the solubilizing nonionic surfactants comprise from about 0.01% to about 20%, preferably from about 0.5% to about 10% by weight of the liquid detergent composition.

Zwitterionic Surfactants

Non-limiting examples of optional zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) sulfo and hydroxy betaines, such as N-alkyl-N,N-dimethylammino-1-propane sulfonate where the alkyl group can be C₈ to C₁₈, preferably C₁₀ to C₁₄. Typically, when present, zwitterionic surfactants comprise from about 0.01% to about 20%, preferably from about 0.5% to about 10% by weight of the liquid detergent composition.

Calcium and/or Magnesium Ions

The presence of calcium and/or magnesium (divalent) ions are utilized to improve the overall cleaning of greasy soils for light-duty liquid detergent compositions. This is especially true when the light-duty liquid detergent compositions are used in softened water that contains few divalent ions. It is believed that calcium and/or magnesium ions increase the packing of the surfactants at the oil/water interface, thereby reducing interfacial tension and improving overall grease cleaning.

Preferably, the magnesium or calcium ions are added as a hydroxide, chloride, acetate, formate, oxide or nitrate salt to the liquid detergent compositions of the present invention. Calcium ions may also be added as salts of the hydrotrope. Calcium and/or magnesium ions may also be formulated into the light-duty liquid detergent composition as a salt of a surfactant such as that described in U.S. Pat. No. 6,506,719, Arvanitidou, et al.

The liquid detergent compositions of the invention may contain magnesium and/or calcium ions and be present in the liquid detergent compositions herein at an active level of from about 0% to about 2%, preferably from about 0.1% to about 2%, more preferably from about 0.2% to about 2%, by weight of the liquid detergent composition.

Solvent:

The liquid detergent compositions of the invention can comprise a solvent in an effective amount so as to reach the desired viscosity of greater than 700 cps, when measured at 20° C. More preferably the viscosity of the composition is between 700 and 1100 cps. Suitable solvents for use herein include low molecular weight alcohols such as C₁-C₁₀, preferably C₁-C₄ mono- and dihydric alcohols, preferably ethyl alcohol, isopropyl alcohol, propylene glycol and hexylene glycol. The compositions herein typically comprise from 0.1% to 20%, preferably 1% to 15%, most preferably 2% to 10%, by weight of the liquid detergent composition of ana solvent.

Viscosity Test Method

The viscosity of the composition of the present invention is measured on a Brookfield viscometer model # LVDVII+at 20° C. The spindle used for these measurements is S31 with the appropriate speed to measure products of different viscosities; e.g., 12 rpm to measure products of viscosity greater than 1000 cps; 30 rpm to measure products with viscosities between 500 cps-1000 cps; 60 rpm to measure products with viscosities less than 500 cps.

Hydrotrope:

The liquid detergent compositions of the invention may comprise a hydrotrope in an effective amount so that the liquid detergent compositions are appropriately compatible in water. By “appropriately soluble in water”, it is meant that the product dissolves quickly enough in water as dictated by both the washing habit and conditions of use.

Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, and related compounds (as disclosed in U.S. Pat. No. 3,915,903).

The liquid detergent compositions of the present invention typically comprise from 0% to 15% by weight of the liquid detergent composition of a hydrotropic, or mixtures thereof, preferably from 1% to 10%, most preferably from 3% to 6%.

Thickening Agent

The liquid detergent compositions herein can also contain from about 0.2% to 5% by weight of the liquid detergent composition of a thickening agent. More preferably, such a thickening agenter will comprise from about 0.5% to 2.5% of the liquid detergent compositions herein. Thickening agentsers are typically selected from the class of cellulose derivatives. Suitable thickeners include hydroxy ethyl cellulose, hydroxyethyl methyl cellulose, carboxy methyl cellulose, QUATRISOFT® LM200, and the like. A preferred thickening agent is hydroxypropyl methylcellulose.

Suds Boosters

The liquid detergent compositions herein can also contain from about 0.05% to 5% by weight of the liquid detergent composition of a suds booster. Suds boosters are utilized for increased suds volume and increased suds retention while washing, especially by hand, dishware. These polymeric suds stabilizers may be selected from homopolymers of (N,N-dialkylamino) alkyl esters and (N,N-dialkylamino) alkyl acrylate esters. The weight average molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely the acrylate ester represented by the formula (III): 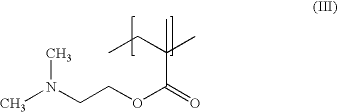
When present in the compositions, the polymeric suds booster may be present in the composition from 0.01% to 15%, preferably from 0.05% to 10%, more preferably from 0.1% to 5%, by weight. Other eExamples of suitable suds boosters are discussed in U.S. Pat. No. 6,207,631, U.S. Pat. No. 6,369,012, U.S. Pat. No. 6,372,708, U.S. Pat. No. 6,528,477, EP 1 223 212, and U.S. Pat. No. 6,645,925 B I.
Other Optional Components:

The liquid detergent compositions herein can further comprise a number of other optional ingredients suitable for use in liquid detergent compositions such as perfume, diamines, dyes, opacifiers, enzymes, builders, chelants, and pH buffering means so that the liquid detergent compositions herein generally have a pH of from 5 to 11, preferably 6 to 11, most preferably 7 to 11. A further discussion of acceptable optional ingredients suitable for use in liquid detergent compositions, specifically light-duty liquid detergent composition may be found in U.S. Pat. No. 5,798,505.

Preferably, the liquid detergent compositions herein are formulated as clear liquid compositions. By “clear” it is meant stable and transparent. In order to achieve clear compositions, the use of solvents and hydrotropes is well known to those familiar with the art of light-duty liquid dishwashing compositions. Preferred liquid detergent compositions in accordance with the invention are clear single phase liquids, but the invention also embraces clear and opaque products containing dispersed phases, such as beads or pearls as described in U.S. Pat. No. 5,866,529, to Erilli, et al., and U.S. Pat. No. 6,380,150, to Toussaint, et al., provided that such products are physically stable (i.e., do not separate) on storage.

The liquid detergent compositions of the present invention may be packages in any suitable packaging for delivering the liquid detergent composition for use. Preferably the package is a clear package made of glass or plastic.

Method of Use

In the method aspect of this invention, soiled dishes are contacted with an effective amount, typically from about 0.5 ml. to about 20 ml. (per 25 dishes being treated), preferably from about 3 ml. to about 10 ml., of the liquid detergent composition of the present invention diluted in water. The actual amount of liquid detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. The particular product formulation, in turn, will depend upon a number of factors, such as the intended market (i.e., U.S., Europe, Japan, etc.) for the composition product. Suitable examples may be seen below in Table II.

Generally, from about 0.01 ml. to about 150 ml., preferably from about 3 ml. to about 40 ml. of a liquid detergent composition of the invention is combined with from about 2000 ml. to about 20000 ml., more typically from about 5000 ml. to about 15000 ml. of water in a sink having a volumetric capacity in the range of from about 1000 ml. to about 20000 ml., more typically from about 5000 ml. to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of use will comprise immersing the soiled dishes into a water bath without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Test Methods

Cooked Grease Screening Method

Pre-weigh a steel metal slide and record the weight. Melt a soil sample of 100 g of CRISCO® shortening from the J.M. Smuckers Company, in an 237 mL (8 fluid ounce (US)) glass jar for 2 minutes in a microwave (high setting ˜1350 W). Place 0.7 g to about 0.8 g of melted soil on the metal slide using a pipette and then cook the metal slide with soil for 30 minutes at 194° C. (381° F.) in a standard oven, such as the Thelco Laboratory Oven, Precision Model 31619. Allow the metal plate to cool to room temperature (20° C.). Weigh the metal slide to determine the cooked soil weight. Prepare a solution of 2100 mL of deionized water adjusted to a 15 gpg hardness and 100 ppm bicarbonate. Heat the solution to 48.9° C. (120° F.). Add the detergent formulation shown in Table II below, to make a 2600 ppm detergent solution. In a TEFLON® jar of 473 mL (16 fluid oz (US)) add 200 mL of the prepared detergent solution and allow the detergent solution to cool to a temperature of 46.1° C. (115° F.). Add the metal plate to the 46.1° C. (115° F.) detergent solution and soak for 2 minutes. Remove the metal plate from the detergent solution to dry for 12 to 14 hours at room temperature (25° C.) and weigh to determine the amount of cooked grease removed.

Formulations

TABLE II

| | For- | For- | For- | For- | For- |
|---|---|---|---|---|---|
| | mula 1 | mula 2 | mula 3 | mula 4 | mula 5 |
| C₁₂₋₁₃ alcohol ethoxylate | 26 | 26 | 18.9 | 26 | 26 |
| sulfate EO = 0.6 | | | | | |
| Amine Oxide | 5.8 | 5.8 | 8 | 3.8 | 5.8 |
| C₈₋₁₂ alcohol ethoxylate | 2 | 2 | 5.8 | 2 | 0 |
| EO = 8 | | | | | |
| sorbitan esters¹ | | | | 2 | |
| C₁₂₋₁₃ alcohol | | 3 | | | 3 |
| ethoxylate² | | | | | |
| HSE 23-3³ | | | 3 | | |
| Ethanol | 2 | 2 | 2 | 2 | 2 |
| Sodium cumene | 1.80 | 1.80 | 1.80 | 1.80 | 1.80 |
| sulfonate | | | | | |
| NaCl | 1.4 | 1.4 | 1.4 | 1.4 | 1.4 |
| MgCl₂ | 0.2 | 0.2 | 0.2 | 0.2 | 0.2 |
| Suds Booster⁴ | 0.2 | 0.2 | 0.2 | 0.2 | 0.2 |
| Poly propylene glycol | 0.8 | 0.8 | 0.8 | 0.8 | 0.8 |
| M_{w} = 200⁵ | | | | | |
| Water & other | To | To | To | To | To |
| trace components | 100% | 100% | 100% | 100% | 100% |
| (i.e., dye, perfume, | | | | | |
| diamine, etc.) | | | | | |

¹such as Span ® (20, 40, 60, or 80)
²available as SAFOL ® 23-3, NEODOL ® 23-3, LUTENSOL ® 23-3
³as described above
⁴as described in formula (III) or as described in U.S. Pat. No. 6,645,925 B1
⁵such as P2000E (PPG-26) available from Dow Chemicals or PLURACOL ® P 2000 available from BASF.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A liquid detergent composition comprising a surfactant system comprising about 1.5 wt % to about 3.5 wt % of the liquid detergent composition of one or more solubilizing nonionic surfactants comprising a hydrophile-lipophile balance number less than 12.5.

2. The liquid detergent composition according to claim 1 wherein the one or more solubilizing nonionic surfactants comprising a hydrophile-lipophile balance number from 12.5 to about 4.

3. The liquid detergent composition according to claim 1 wherein the solubilizing nonionic surfactant is selected from the group consisting of alcohol alkoxylates, mid-chain branched alkoxylates, sorbitan monopalmitate, sorbitan monooleate, sorbitan monostearate, polyoxyethylene(4) sorbitan monostearate, polyoxyethylene(20) sorbitan tristearate, polyoxyethylene(5) sorbitan monooleate, polyoxyethylene(20) sorbitan trioleate, and mixtures thereof.

4. The liquid detergent composition of claim 1 further comprising from 30% to 95% by weight of the liquid detergent composition of a aqueous liquid carrier; and the surfactant system further comprises: from 5% to about 50% by weight of the liquid detergent composition of an anionic surfactant; from about 0% to about 20% by weight of the liquid detergent composition of an amine oxide; from about 0% to about 20% by weight of the liquid detergent composition of a nonionic surfactant other than the solubilizing nonionic surfactant.

5. The liquid detergent composition according to claim 1 wherein the surfactant system further comprises a nonionic surfactant, other than the solubilizing nonionic surfactant, selected from the group of alcohol alkoxylates having from 12 to 13 carbon atoms and having an average degree of alkoxylation of from about 1 to about 5, secondary alkoxylated surfactants, linear alcohol surfactants, mid-chain branched alcohol surfactants, secondary alcohol surfactants, and mixtures thereof.

6. The liquid detergent composition according to claim 1 wherein the surfactant system further comprises an amine oxide having the formula: 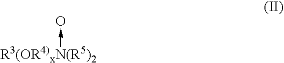
wherein R³ of formula (II) is an alkyl, hydroxyalkyl, or alkyl phenyl group or mixtures thereof containing from about 8 to about 22 carbon atoms; R⁴ of formula (II) is an alkylene or hydroxyalkylene group containing from about 2 to about 3 carbon atoms or mixtures thereof; x of formula (II) is from 0 to about 3; and each R⁵ of formula (II) is an alkyl or hydroxyalkyl group containing from about 1 to about 3 carbon atoms or a polyethylene oxide group containing from about 1 to about 3 ethylene oxide groups.

7. The liquid detergent composition according to claim 4 wherein the anionic surfactant is selected from the group of C₁₁-C₁₈ alkyl benzene sulfonates, C₁₀-C₂₀ primary, branched-chain and random alkyl sulfates, C₁₀-C₁₈ alkyl alkoxy sulfates, mid-chain branched alkyl sulfates, mid-chain branched alkyl alkoxy sulfates, and mixtures thereof.

8. The liquid detergent composition according to claim 4 further comprising from 0.1% to 2% by weight of the liquid detergent composition of magnesium ions, calcium ions, and any mixture thereof.

9. The liquid detergent composition according to claim 4 further comprising from 0.1% to 20% by weight of a solvent and from 0% to 15% by weight of a hydrotrope.

10. The liquid detergent composition according to claim 4 further comprising from about 0.05% to about 5% by weight of a suds booster.

11. The liquid detergent composition according to claim 4 further comprising from about 0.2% to about 5% by weight of a thickening agent.

12. The liquid detergent composition according to claim 1 wherein the liquid detergent composition is a clear liquid.

13. A method of washing dishes with the liquid detergent composition according to claim 1, wherein 0.01 ml to 150 ml of said liquid detergent composition is diluted in 2000 ml to 20000 ml water, and the dishes are immersed in the diluted composition thus obtained and cleaned by contacting the soiled surface of the dish with a cloth, a sponge or a similar article.

14. A method of washing dishes, wherein the dishes are immersed in a water bath, an effective amount of a liquid detergent composition according to claim 1 absorbed onto a device, and the device with the absorbed liquid detergent composition is contacted individually to the surface of each of the soiled dishes.
